(19) United States
(12) Patent Application Publication
(10) Pub. No.: US 2011/0267598 A1
(43) Pub. Date: Nov. 3, 2011

(54) OPTICAL SENSOR SYSTEM AND DETECTING METHOD FOR AN ENCLOSED SEMICONDUCTOR DEVICE MODULE

(75) Inventors: Thomas Hjort, Vejle Ost (DK); Lars Glavind, Randers C (DK)

(73) Assignee: VESTAS WIND SYSTEMS A/S, Randers SV (DK)

(21) Appl. No.: 13/011,410

(22) Filed: Jan. 21, 2011

Related U.S. Application Data
(60) Provisional application No. 61/329,790, filed on Apr. 30, 2010.

(30) Foreign Application Priority Data
Apr. 30, 2010 (GB) 1007355.9

(51) Int. Cl. G01B 11/16; G02B 6/00

(52) U.S. Cl. 356/32; 385/12

(57) ABSTRACT

A sensor system and method for a power electronics module is discussed. The system comprises a optical fibre 318 mounted inside the module housing 302 and connected to an external sensor system 320 (not shown). The optical fibre 318 is arranged so that it lies proximate to one or more semiconductor dies 308 within the housing, and can sense their temperature. The fibre can be connected to the die 308 by glue, mechanical connection, or can in other examples by provided in the underlying support structure such as a DCB (direct copper bonded ceramic structure) or base plate 304. The fibre can contain an optical grating, such as an FBG or LPG, or can operate based on interferometry, to detect temperature or strain.

### CROSS-REFERENCE TO RELATED APPLICATIONS

The present application claims the benefit of U.S. Provisional Application No. 61/329,790, filed Apr. 30, 2010, and claims priority under 35 U.S.C. §119 to United Kingdom Patent Application GB1007355.9, filed Apr. 30, 2010. The content of each of these applications is hereby incorporated by reference herein in its entirety for all purposes.

### BACKGROUND

The invention relates to an optical sensor system and detecting method for an enclosed semiconductor device module, and in particular to embodiments for use in a power electronics module or a microprocessor with housing.

A power electronics module is a device that houses a plurality of power system components, such as semiconductor devices often used to switch high currents and voltages. In such applications, the semiconductor devices are often MOSFETs (metal Oxide Semiconductor Field Effect Transistors) or IGBTs (Insulated Gate Bipolar Transistors), as these offer high efficiency and fast switching.

A known power electronics module 10 is illustrated in FIGS. 1 and 2 to which reference should now be made.

FIG. 1 illustrates the exterior of the module 10. The module 10 comprises a plastic housing 102 attached to metallic base plate 104 by one or more screws (not shown), and/or adhesive. The metallic base plate 104 provides a sturdy base on which the electronics components for the interior of the housing can be mounted, and allows the device as a whole to mounted in an electrical cabinet or other structure by retaining screw holes 106.

A number of metallic primary electrical terminals 108 are provided in an accessible location on the face of the plastic housing 102 of the module, with a number of secondary terminals 110 being located at the sides.

FIG. 2 illustrates the interior of the module shown in FIG. 1. In this view, the metallic base plate 104 can be seen to support a number of sections 202 of a DCB 204 (direct copper bonded ceramic structure), each in turn supporting a number of semiconductor devices. In the example shown, each section 202 supports two IGBTs 206 and two diode components 208 located between copper bus bars 210 and 212. Each of the copper bus bars 210 have tabs 211 for engaging with corresponding connections on the underside of the primary electrical terminals 108. Corresponding copper terminals 214 are provided on the metallic base plate 104 for engaging with secondary terminals 110.

The interior of the plastic housing is usually filled with an insulating material for safety, such as a potting material or foam (not shown).

In use, one of the copper bus bars 210 or 212 is used as in input and the other as an output terminal, with the electronics components IGBT 206 and diode 208 controlling the switching action between the terminals. As a result of operating and switching losses, the semiconductor devices forming the IGBT 206 and diode 208 can become very hot, and it is necessary to carefully monitor their temperature for safety reasons, as well as to avoid failure of the module.

There are a number of known methods for measuring the temperature of the components inside a power electronics module such as that shown in FIGS. 1 and 2, however as will be explained below, all methods are currently unsatisfactory and have a number of inherent disadvantages.

One known method is to calculate the dissipated power in the components of the power module from a measurement of instantaneous current flowing through them. This technique is described by way of example in US2008/0191686. Current sharing measurements such as these are often impractical in commercial implementations.

A further known method is to use thermocouples connected across the semiconductors device IGBTs 206 and diodes 208. However, due to switching noise in the IGBT 206, in order to measure the thermocouple current, it is often necessary to deactivate the switch, and measure the current immediately afterwards. In systems which are efficiently cooled, this leads to a measurement that does not accurately reflect the operating temperature of the power electronic components. As an alternative to thermocouple devices, some temperature sensing systems use platinum resistance thermometers or thermistors, such as PTC (Positive Temperature Coefficient) or NTC (Negative Temperature Coefficient) thermistors. However, to operate these devices must necessarily draw some current.

A drawback with these techniques is that they require galvanic connections that extend from the interior of the power electronics module to the exterior for sensing and control purposes. This can cause interference in the operation of the device, can draw noise out of the module, and can compromise safety if the connections are not correctly isolated.

We have therefore appreciated that there is a need for an improved sensor system for a power electronics module.

### BRIEF SUMMARY

The invention is defined in the independent claims to which reference should be made. Advantageous features are set forth in the dependent claims to which reference should be made.

In a first aspect the invention provides, a semiconductor device module having a housing defining an interior in which at least one semiconductor device is housed; the module comprising an optical fibre located at least partially inside the housing and arranged to detect an operating parameter representing a condition in the housing.

The use of an optical fibre allows detection without disturbing the operation of the sensitive electronic components in the housing. In addition, the optical fibres are not themselves likely to be damaged by the high operating temperatures within the module.

In one embodiment, the operating parameter is the temperature inside the housing or the temperature of an electronic device inside the housing. In alternative embodiments, the operating parameter is: the strain experienced at a location inside the housing or of the strain experienced by an electronic device inside the housing; the electric or magnetic field strength at a location inside the housing or of the current flowing through an electronic device inside the housing; or an indication of whether an electrical discharge or electrical arcing event is occurring inside the housing.

In one embodiment, the at least one electronic device is formed as a die, and the optical fibre is attached to the die by heat resistant adhesive, thus ensuring a secure thermal contact and improving the accuracy of the sensor. The heat resistant adhesive may be a glass reinforced epoxy resin.

In one embodiment, the optical fibre is attached to the die by a bonding wire formed over the fibre.

In a further embodiment, the optical fibre is coated with a flexible coating layer, which can be used to reduce stresses in the optical fibre caused by difference in the thermal expansion of the fibre and the die. The flexible coating layer can be one or more of silicone, polyimide, non-viscous cream, thermal insulating compound, heat sink paste.

In alternative embodiments, the semiconductor device module can comprise a DCB, and the optical fibre is located inside one of the layers of the DCB, and/or a base plate, in which an optical fibre is located. The optical fibre can also be located in the soldering or thermal interface material between components.

In one embodiment, the semiconductor device module is a power electronics module. Such devices are particularly prone to operating at high temperatures, and can therefore benefit from a sensing system of the type discussed above to ensure that they operate safely.

In a further aspect of the invention, a semiconductor device module control system is provided having the semiconductor device module discussed above; a detector for detecting an optical signal or electromagnetic radiation output from the optical fibre; a controller coupled to the detector, and arranged to determine an operating parameter representing a condition inside the housing based on the optical signal or electromagnetic radiation.

In conjunction with the sensor system discussed above, the operation of the module can be made more safe and/or efficient. In one example, the controller can be arranged to shut off the power to the power electronics module based on the operating parameter. Additionally, or alternatively, the semiconductor device module control system comprises a cooling system coupled to the controller and operable based on the operating parameter.

The apparatus described above can advantageously be used in a wind turbine given the remote siting of wind turbines and the need to ensure they do not suffer operational problems. The module and system are not so limited however.

In a further aspect the invention provides a corresponding control method.

### BRIEF DESCRIPTION OF THE SEVERAL VIEWS OF THE DRAWINGS

The invention is described in more detail, by way of example, with reference to the drawings in which;

FIG. 1 is a schematic illustration of the exterior of a power electronics module;

FIG. 2 is a schematic illustration of the interior of a power electronics module;

FIG. 3 is an isometric view of a power electronics module according to an example of the invention;

FIG. 4 is a schematic view of the power electronics module shown in FIG. 3 including a sensor suite;

FIG. 5 is an schematic isometric view of a die having an attached optical fibre;

FIG. 6 is a further schematic isometric view of a die having an attached optical fibre;

FIG. 7 is a cross sectional view through lines VII-VII of FIG. 6;

FIG. 8 is a cross sectional view through line VIII-VIII of FIG. 6;

FIG. 9 is a schematic illustration of a first example mechanical connection for the optical fibre;

FIG. 10 is a schematic illustration of a second example mechanical connection for the optical fibre; and

FIG. 11 is a schematic illustration of a third example mechanical connection for the optical fibre.

### DETAILED DESCRIPTION

Generally, the invention involves the provision of an optical fibre sensor system to a enclosed semiconductor device, such as a power electronics module or microprocessor with housing, to monitor its operation.

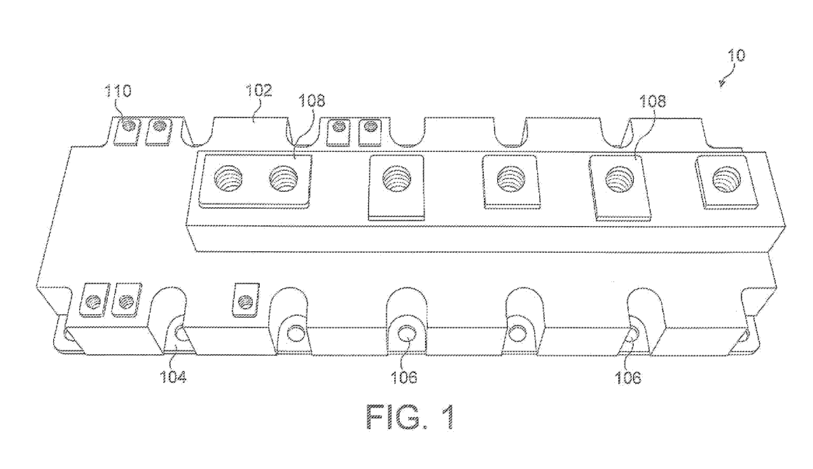

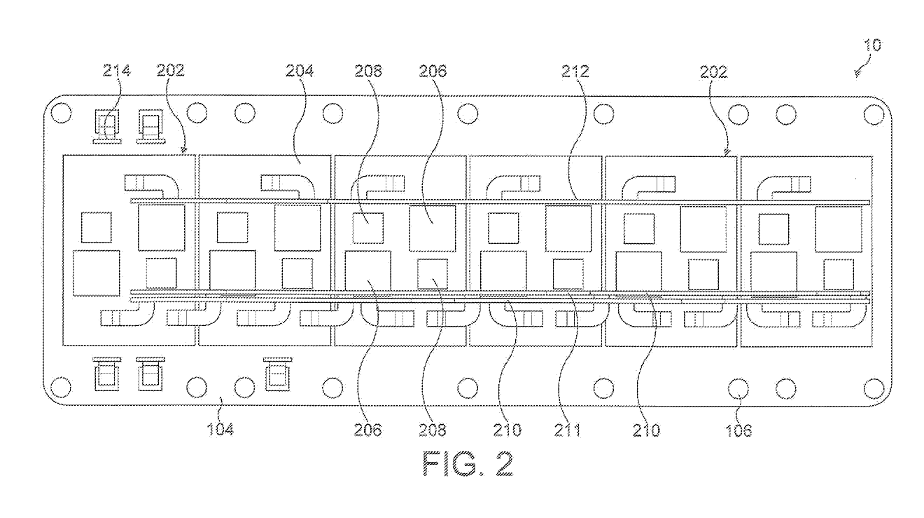

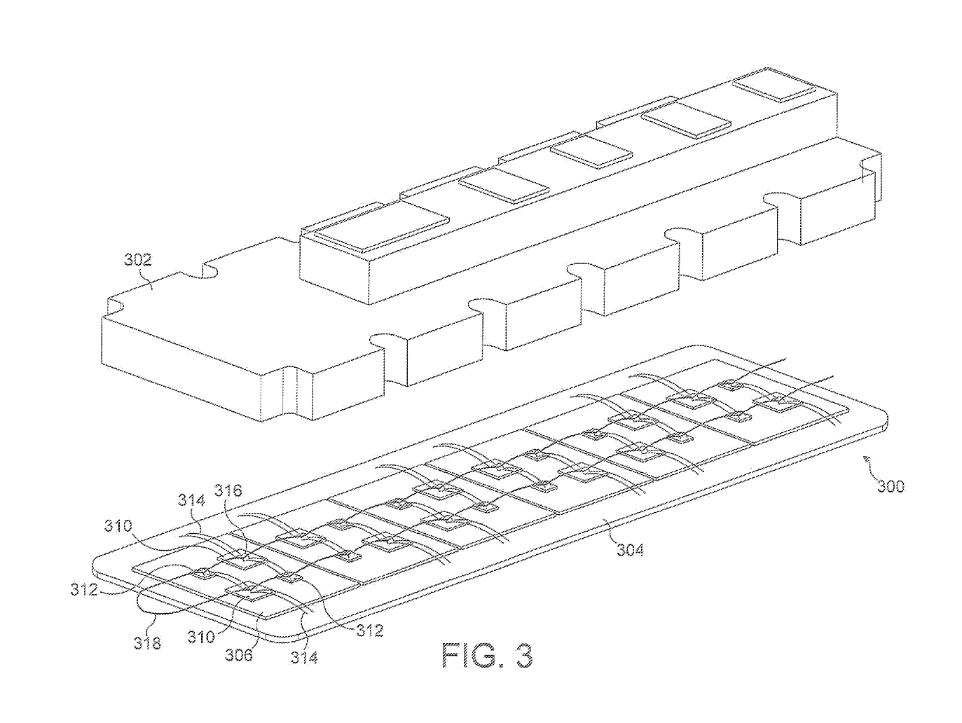

A particular example of the invention in a power electronics module will now be described with reference to FIG. 3. For the purposes of illustration, the construction of the power electronics module will be assumed to be largely identical to the devices shown in FIGS. 1 and 2. The module 300 has a plastic housing 302 with a copper base plate 304, onto which a DCB 306 is soldered or connected thermally with a suitable thermal interface material. The connection between the base plate and the DCB 306 could also be by so-called sintering processes. The base plate provides a sturdy base for the assembly and assists in spreading the heat from the plurality of active semiconductor devices, known as dies, mounted on the DCB 306.

The DCB 306 is formed of a ceramic material onto which two layers of copper are bonded directly. The DCB provides electrical isolation between the dies and the base plate, but equally importantly ensures that the thermal expansion of the different materials used in the module is controlled.

The plurality of active semiconductor devices 308 are soldered onto the DCB 306 using high temperature soldering, but could also be sintered if appropriate. The dies are essentially a piece of silicon crystal that is cut and processed so that it can control a flow of current through it and block a voltage across it. The plurality of dies typically include one or more switching devices, such as IGBTs 310 and diodes 312 arranged in a staggered formation on the DCB 306 to spread more evenly the locations at which the base plate will receive heat.

A number of bonding wires 314 are attached to the on-chip terminals 316 of the IGBT 310 and diodes 312 to form the necessary electrical connections for the power module 300. As before, the power module 300 is likely to have a number of copper bus bars or leads for connection to the power supply, though these are not shown in FIG. 3 to avoid obscuring the diagram, and will be understood to be not strictly part of the invention.

As shown in FIG. 3, a fibre optical cable 318 is provided inside the module 300, arranged so that it lies in proximity to one or more of the dies 308. As will be explained below, at least one section of the optical fibre is preferably placed in thermal contact with a die so that in operation it attains the same temperature as the die to which it is attached.

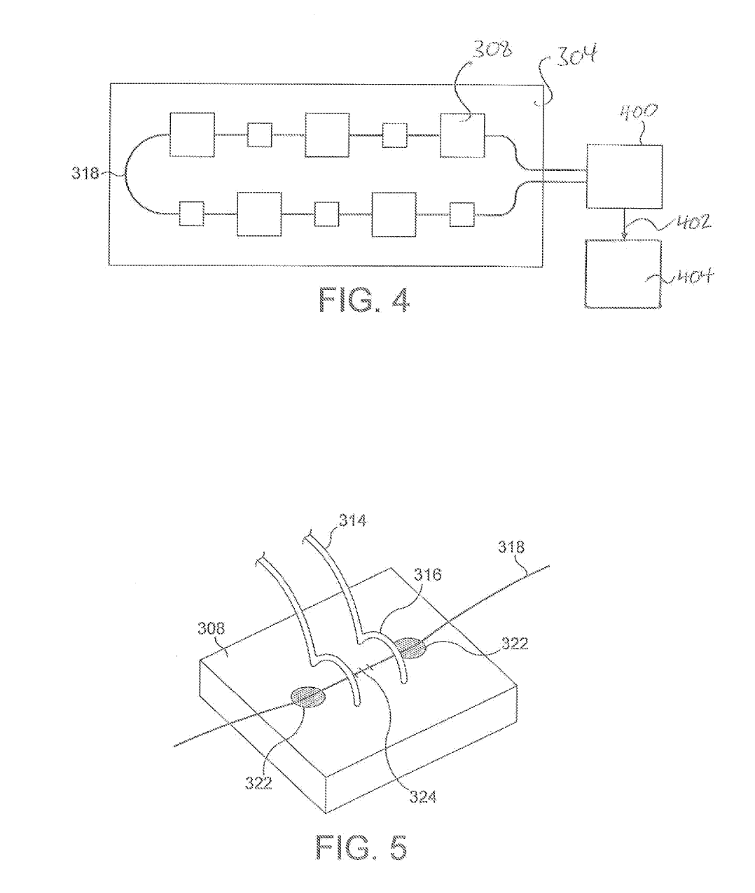

Referring now to FIG. 4, the optical fibre 318 is led out of the power electronics module housing 302 to a sensor suite 400 comprising a light source for feeding the optical fibre, and a light detector for receiving the returned light signal. It will be appreciated the sensor suite 400 also has a memory for recording data received from the optical fibre 318, and at least one processor for analysing the data, monitoring conditions in the device, and providing an output 402 to a controller 404. Based on the output 402 of the sensor suite 400, the controller can take various actions to ensure safe operation of the semiconductor device module or power module. Such actions can include one or more of shutting down the power electronics module 300, or the electronic system in which the power electronic module is housed (for example an electrical cabinet), modulating the input power signals to the device, activating an emergency cooling system, issuing an alarm signal to summon an engineer, logging the event and recording any associated information received from the sensor suite. The sensor suite 400 and controller 404 are located a sufficient distance from the module 300 to avoid electrical interference or potential damage, and can be provided separately or as a single integrated unit. The controller can be omitted in applications where only a log of the sensor data is required.

The operation of the optical fibre 318 and sensor system 400 will now be explained in more detail. A light signal is generated by the light source in the sensor suite 400 and is inserted into the end of the optical fibre 318. The light that has travelled along the optical fibre 318 is subsequently at the detector 400 where it can be analysed. Depending on the details of the implementation, the light received at the sensor suite 400 may have travelled along the entire length of the fibre 318, or may have been reflected back from an intermediate point. In one embodiment, the sensor suite 400 can include two pairs of light sources and detectors, one pair arranged at each end of the optical fibre to provide redundancy in the system.

As is known in the art, the optical properties of the optical fibre cable will be affected by changes in its temperature. For example, as a section of the optical fibre experiences a change in the temperature it will undergo thermal expansion and a change in refractive index. These changes can be detected by detecting changes in the optical properties of the light inserted into the fibre and subsequently re-emitted from the optical fibre and captured by the detector 400.

In the case of interferometry sensing techniques, changes in the optical path length provided by the optical fibre 318 due to changes in its physical length or refractive index are used to provide an indication of temperature. The light emitted from the fibre is allowed to interfere with light from the light source, which has not passed along the same optical fibre, to form an interference signal. The magnitude of the interference signal will be sensitive to the phase difference between the received signal compared to that of the original light signal. Thus, providing the wavelength of the original light source is chosen to give an interference signal sensitive to the length changes experienced by the optical fibre 318, the magnitude of the interference signal can be used as a measure of the temperature of the optical fibre and therefore the dies to which it is attached. A suitable range of wavelengths are those corresponding to visible light and the near Infrared region of the EM spectrum. Particular wavelengths are selected depending on the propagation properties of that wavelength in the fibre and the desired resolution of the sensor.

Fibre Bragg Grating (FBG) techniques are also known, in which an optical grating is formed in the optical fibre, typically using a UV laser. The grating is tuned in the sense that it will reflect a particular wavelength of light determined by the grating dimensions. If the section of the optical fibre 318 having the FBG is placed next to or in contact with the die 308, then the changes in the length of the optical fibre at that location, will result in a change in both the dimensions of the FBG and the refractive index of the optical fibre. Both effects alter the wavelength of any the light reflected and/or transmitted by the FBG, which can therefore be used as a measure of the temperature of the optical fibre and the die at that location. Long Period Gratings (LPGs) may also be used in similar fashion to FBGs, although in practice with LPGs it is typically only the wavelengths of the light that are transmitted that are used as the basis of the sensor, rather than those reflected. In the following discussion the two terms are used interchangeably, where appropriate.

FBGs are advantageous as a single optical fibre can be provided with a plurality of FBGs, each sensitive to a different wavelength of light, and each corresponding to a different location and sensor site having a die 308. Thus, the temperature of a particular die 308 can be determined in isolation by inserting light of the corresponding wavelength. In such techniques, the light source may usefully be narrow spectrum or wide spectrum, tuned or non-tuned. It is possible to use a plurality of FBGs that reflect/transmit light at fundamentally the same wavelength. In this case Time Division Multiplexing is required to distinguish the different sensor signals from each FBG.

The light source itself can be any suitable opto-electronic light source, such as light emitting diode, laser similar devices.

Interferometry techniques can also be used based on the changes in length and refractive index of the optical fibre with temperature. These can readily be used to determine the temperature over a larger area, such as generally on the base plate 304 or DCB 306, as well as for individual dies. Where interferometry techniques are to be used to detect the temperature of individual dies, respective optical fibres 318 can be provided corresponding to each die position 308 and can be separately sensed by corresponding sensor electronics in suite 400.

FIG. 5 shows in more detail an example of how the attachment of the optical fibre 318 to the die 308 can be achieved. The optical fibre is preferably selected to have the same thermal expansion properties as the silicon die. We have found that FBG optical fibres from O/E Land Inc, such as OEFBG-100A, FBG optical fibres from AOS Gmb, such as incorporating Corning SMF28, and the Clearlite Speciality Coated Photonic Fibres, such as the Carbon/Poly 1310 11 and CL Poly 1310 11 models have all produced good results, although other manufactures and types of fibre could be used depending on any particular requirements of the implementation. A secure attachment to the die can be achieved using a glue or adhesive 322 such as a glass reinforced epoxy which can also be selected to have a similar or substantially identical thermal expansion to the silicon die 308 and optical fibre 318 to which it is attached. The attachment could also be made using Silicone Gels, such as SilGel®. Small differences in thermal expansion coefficient may result in strain being introduced into optical fibre through the different expansion of the epoxy resin glue 322, and inaccuracies in the temperature measurement, and so should be avoided or mitigated where possible.

Non-limiting examples of epoxy resins that can be used in this regard are UHU's UHU Plus Endfest 300 epoxy resin, modified acrylate, and the EPO-TEK® 353ND-T or 930-4. Additionally, acrylic adhesives can also be used, such as Loctite® Product Output® 315 and similar products for example. In alternative embodiments, solder could also be used to attach the optical fibre in place.

In FIG. 5, the epoxy resin is shown as applied to the optical fibre 318 at the edge of the die 308. This allows a site at which the FBG is installed to be removed from the influence of the thermal expansion of the epoxy resin. The adhesive 322 may also be applied off-die to attach the optical fibre 318 to the DCB 306 if this is preferred.

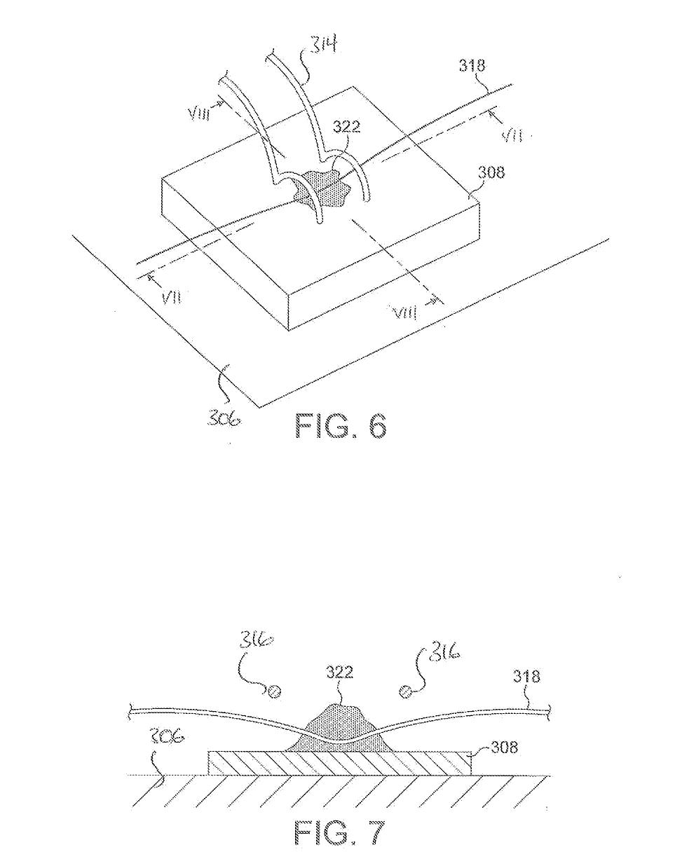

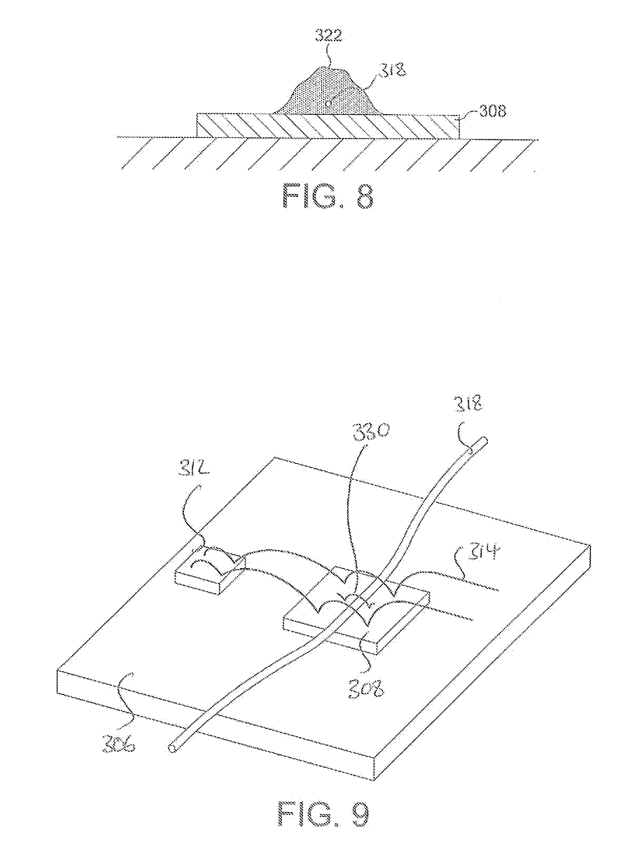

Alternatively, the optical fibre 318 can be coated with a thin flexible layer of material, such as silicone, polyimide, non-viscous cream, thermal insulating compound, heat sink paste or similar material, that while not significantly affecting the thermal properties of the fibre provides some leeway or slip between the optical fibre 318 and the point of attachment with the adhesive 322, thereby relieving strain on the fibre and the die. In such cases, the positioning of the adhesive 322 is less critical and could be applied to the centre of the die under the bonding wires, to hold the optical fibre 318 securely in position. This arrangement is shown in FIGS. 6, 7 and 8. FIGS. 7 and 8 are cross-sections through the isometric view of FIG. 6 along lines VII-VII and VIII-VIII respectively.

Dies 308 intended to operate with voltages that are higher than 50 V are typically provided with a guard ring. This is a glass isolation barrier at the edge of the die, such that when housing 302 is filled with a potting material, the glass barrier forms a voltage barrier reducing the risk of a short-circuit between adjacent dies, or between parts of the same die with a high potential difference. As the optical fibre 318 is made from glass or silicon, while it is uncontaminated with dirt or foreign matter, placement on or near the guard ring will have little effect on the system. However, any contaminants on the surface of the fibre could create a conductive path and compromise the insulation provided by the guard ring. Ensuring the cleanliness of the optical fibre at installation is therefore a priority, and the adhesive 322 should not contact the guard ring when it is applied.

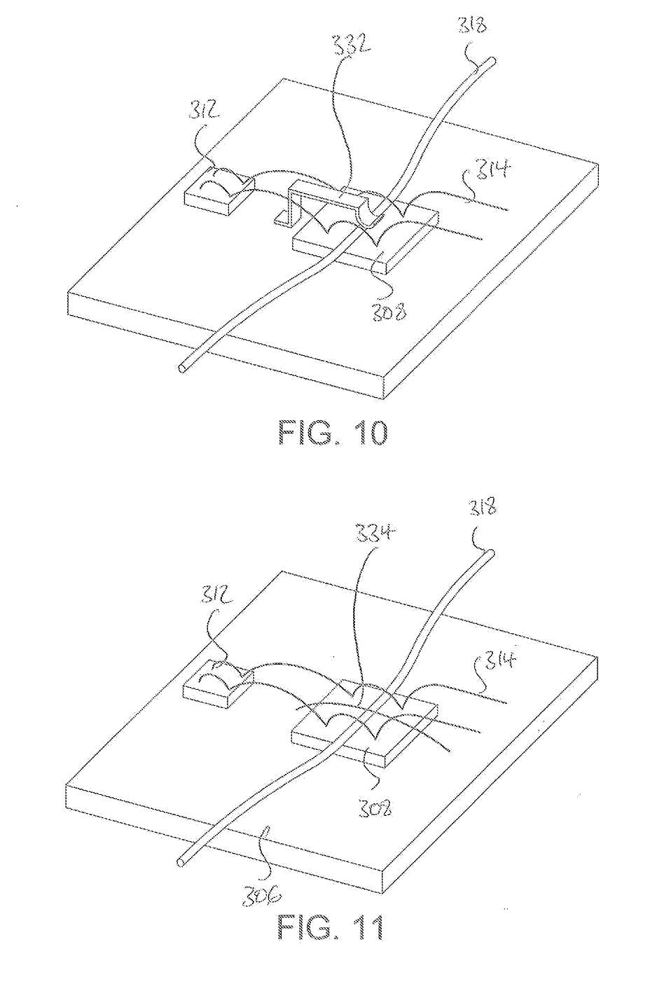

In the examples shown in FIGS. 6, 7 and 8 referred to above, the optical fibre 318 is attached to the top of the die 308 by adhesive. In alternative examples, however, contact between the optical fibre 318 and the die 308 may be achieved through mechanical means such as one or more bonding wires 330 formed over the fibre, such as that shown in FIG. 9, by means of a spring attachment 332 as shown in FIG. 10, or by means of a further wire or tie attachment 334 spanning from one side of the DCB to the other and holding the fibre 318 in place as in FIG. 11. In FIG. 9, the bonding wire should not be in contact with any of the other components of the die or system to avoid heating up. In FIG. 10, the spring is metal soldered, welded or attached with adhesive to an area on or near the die, or is some other resiliently deformable material, such as a suitable non-conductive or reinforced plastic, held in place by adhesive. In FIG. 11, the wire or tie attachment 334 may be conductive or non-conductive.

In an alternative embodiment, the fibre could be held in place by appropriate use of the potting material used in the housing, as this will to some extent act as a cement.

In all of these diagrams, the optical fibre at its point of attachment on the die has been shown lying in a straight line. In alternative embodiments, it can however be advantageous to arrange the optical fibre differently, such as in a U shape or loop.

Additionally, to the above, the fibre could be incorporated into the power electronics module at other locations within the layered base and die structure. Examples include:

embedding the fibre in the die, for example;

embedding the fibre in the copper layer of the DCB 306. Both the top and bottom layers are acceptable, as the optical fibre will not be sensitive to the temperature of the soldering process by which the die 308 is attached to the DCB or baseplate;

embedding the fibre in the ceramic layer of the DCB 306;

embedding the fibre in the base plate 304 or soldering.

The optical fibre 318 and the sensor suite 320 discussed above form part of a sensing and a control system for the power electronics module 300, that can therefore operate based on an accurate and real time measurement of temperature of one or more individual dies in the module. This allows quick and effective control of the module 300 to be achieved when a fault or abnormal condition is indicated by a temperature reading.

In one example, the control system can be configured to shut down the power supply to the power electronics module or to the electrical cabinet in which it is housed, when the temperature of a die 308 is detected to be too high. This avoids the die 308 failing, and avoids the risk of potentially catastrophic short circuits or arcing events that could destroy the die or indeed the module and cabinet in which it is housed. As the measurement of temperature can be made more accurately than with known systems, it is possible to have more certainty as to the state of the die and also operate the die 308 more closely to its operational temperature limit.

This means that the chip can be constructed in a more cost effective manner and with lower tolerances, and means that the chip and module in which it is housed need only a low design margin to accommodate uncertainties in operational temperature. The power electronics module can similarly be constructed more efficiently, as a margin for internal or external paralleling of the dies is no longer required.

In a particular example, where the power electronics module is used in a wind turbine nacelle or substation, then providing the temperature of the device does not exceed a safe operational limit, the control system can allow the power electronics module to remain operational through short overloads without damage. This achieves better interaction with the electricity grid in supporting the electrical load, and provides inertia backup.

In a further example, the control system can operate a cooling system to ensure that the operational temperature of each of the plurality of dies 308 is maintained within safe limits. This has the potential of increasing the lifetime of the power electronics module by up to 5 times. In this way, degradation of the cooling system could also be detected, as ineffective cooling would lead to a steady increase in temperature that could be detected and used to trigger an alarm signal alerting a maintenance engineer in advance of it being necessary to shut down the device.

In further examples, the control system can be used to operate the cooling system more intelligently to provide a flow guard function, partially blocking gas or liquid cooling, where activation of the cooling system inadvertently leads to a local increase in temperature of a particular die, such as when heat from one die is circulated by the cooling system. This can be achieved providing the temperature of the dies is individually monitored and the cooling system can be controlled locally with respect to different regions of the housing. In this way, early failure detection of solder joints or bonding wire lift-off is also possible.

Additionally, the control system can be used to collect data on the real time operation of the power electronics module, which can then be used for further design optimisation, and reporting. Thermal models and loss simulations can be improved using the data, and device lifetime estimations can be provided to the device operator. For internal paralleling, the loss distribution between dies can be monitored ensuring the correct functioning of all parallel dies, while for external paralleling, the loss distribution between separate modules can also be monitored.

The combination of the fibre optic sensor 318 and the sensor suite 320 therefore provides a number of advantages over prior art power electronics modules, in addition to avoiding the need to install current sensors with galvanic connections inside the housing.

Although, the optical fibre has been described in conjunction with an example for sensing temperature, in other examples, optical fibres may be installed to measure strain on the dies 308 or the base plate 304, the current flowing through the busbar or other component, and the strength and characteristics of the electrical or magnetic fields within the housing. In such embodiments, the optical fibre may be constructed so that it has a grading for detecting thermal effects, such as temperature changes, and another grading for optically detecting changes in the magnetic or electrical field. The optical fibre can also be used in a line of sight sensor system with a light detector sensitive to visible or Infra Red frequencies. This can be achieved simply by arranging the optical fibre so that an exposed end of the cable is orientated towards the die 308 or region of the power electronics module of interest, so that it will capture any emitted light or infrared frequency electromagnetic radiation. If necessary, a lensing or light collection system can be provided to ensure that as much of the emitted radiation is captured as possible. This essentially allows the optical fibre to act as a thermal imaging camera, and the temperature of the visible die 308 or module region can be deduced by the processing electronics. No light source to power the fibre is required in this embodiment.

A further application of the optical fibre inside the power electronics housing is in an electrical discharge or arc sensor. Owing to the limitations on available space within many electrical power systems, electrical components are often arranged in such a way that the separation between the components is no smaller than a minimum prescribed value. The minimum prescribed value for the separation is determined according to the nature and voltage of the electrical equipment installed, and is based on the assumption that the atmosphere inside the housing can be treated largely as an insulator. The atmosphere in high power electronics modules is often evacuated and replaced by an insulating potting material that can be treated as an insulator up to a threshold voltage at which it begins to break down.

Electrical faults in electrical systems often begin with a small electrical discharge occurring at a site of a mechanical or electrical defect, such as where there is a protruding metallic component (such as a misplaced screw), where a connection has become loose, or where there is an air gap in the potting material. An initially small spark or electrical discharge can partially ionise the atmosphere and cause the conductivity of the atmosphere to increase. As a result, the prescribed minimum separation between components is no longer sufficient, given the voltages involved, and electrical arcing or flash-overs occur between components. This can quickly result in a cascade of further electrical discharges, accumulating to the point where the energy delivered into the electrical cabinet from the discharge is sufficiently large to cause the cabinet and electrical gear to explode. The time between the initial minor discharge and the catastrophic failure can be a matter of only a few milliseconds.

In this example, rather than using the end of the optical fibre to collect the light from the flash or arcing event, the length or sides of a fluorescent optical fibre are used to collect the emitted electromagnetic radiation, which in the case of arcing events typically starts in the ultraviolet and moves into the visible. This allows the optical fibre to detect the flash of an electrical discharge over an extended area within the housing outside of the cabinet are no longer required.

Fluorescent Optical Fibres (FOF) typically contain a fluorescent material in one or more of the outer cladding or core. The fluorescent material may be included in the fibre optic by doping or by dissolving the material into the fibre material during production. The FOF core may be made of glass, quartz, or plastic. Plastic Optical Fibres (POF) include those made from PMMA (polymethyl methacrylate), polystyrene, polycarbonate (PC), or other suitable polymers, including fluorinated plastics such as perfluorinated polymers. The cladding may be of a similar material to the core, with a suitable refractive index for total internal reflection to occur over the likely wavelength of remitted light, or more generally include one or more plastic materials, either alone or in a blend, such as PMMA, PVDF (Polyvinylidene Fluoride) or fluorinated polymers. Any suitable width of optical fibre can be used. In this example, the width of the optical fibre can be in the range 0.125 mm to 5 mm. Suitable materials for the fluorescent material may be one or more naturally occurring or synthetic fluorescents, such as perylene dye, or BBOT (5-tert-butyl-2-benzoxazolyl thiophene), samarium ions (Sm³+), or any suitable rare earth metals. Fluorescent optical fibres available commercially can also be used.

Example embodiments of the invention have been described for the purposes of illustration. These should not however be taken as limiting the scope of protection for the invention which is defined in the attached claims. Further variations and embodiments will occur to the skilled person.

The example described above relates to a power electronics module comprising a plurality of semiconductor dies in a switching application. However, the same advantages and benefits of this example will be apparent in uses in other fields such as microprocessors, and indeed in any electrical system involving an arrangement of semiconductor devices or dies that are in an enclosed or inaccessible housing. These can include PC's or other consumer electronics.

Generally, the term die can be understood as any part of a disc of silicon crystal wafer that has undergone processing to achieve one of several functions. As will be known to those skilled in the art such processing may involve photo processing, polishing, metalizing, etching and glass passivation for example. Functions can include diodes, such as PNs and Silicon Carbide devices (SiCs), thyristors such as self commutated rectifiers (SCRs), gate turn off thyristors (GTOs) insulated gate commutated thyristors (IGCTs), transistors such as Bipolar junctions (BJT), Field Effect Transistors (FETs), Junction Field Effect Transistors (JFETs), Insulated Gate Bipolar Transistors (IGBTs) Metal Oxide Surface Field Effect Transistors (MOSFETs), and Silicon Carbide Devices, processors such as Digital Signal Processors (DSP), Microprocessors, Fast Programmable Gate Arrays (FPGAs) ASIC's, RAMs and ROMs, and discrete logic circuits.

The power module 300 is constructed with care as there are many construction and lay out-dependent factors that influence the functions and life expectancy of such a device. Furthermore, care must be taken when inserting anything into the housing 302 or when attaching anything to the die 308. With legacy temperature measurements, metallic sensors have always been used, and as a result application in anything other than test scenarios is impossible. The proposed solution of an optical fibre is however non-intrusive and can for the first time be used in devices that are deployed in the field.

The power electronics module described above has application to a wide variety of industries. It is particularly advantageous however when used in wind turbines, due to the inaccessibility of wind turbine locations and the attendant difficulty of maintaining wind turbine equipment remotely. For example, the nacelle of a wind turbine houses high power electronics and equipment necessary for the generation of electricity, and the power module described above allows the electronic components in the wind turbine nacelle to be and safely controlled and additionally monitored by sensor suite 320. Signals from the sensor suite 320 output at output 322 can then be transmitted via a network from each individual wind turbine to a network controller.

The invention has been described by way of a number of illustrative examples, and it will be appreciated that these are not intended to limit the scope of protection which is defined by the claims.

1. A semiconductor device module comprising:
a housing defining an interior in which at least one semiconductor device is housed; and
an optical fibre located at least partially inside the housing and arranged to detect an operating parameter representing a condition in the housing.

2. The semiconductor device module of claim 1 wherein the operating parameter is the temperature inside the housing or the temperature of an electronic device inside the housing.

3. The semiconductor device module of claim 1 wherein the operating parameter is the strain experienced at a location inside the housing or of the strain experienced by an electronic device inside the housing.

4. The semiconductor device module of claim 1 wherein the operating parameter is the current flowing at a location inside the housing or of the current flowing through an electronic device inside the housing.

5. The semiconductor device module of claim 1 wherein the operating parameter is an indication of whether an electrical discharge or electrical arcing event is occurring inside the housing.

6. The semiconductor device module of claim 1 wherein the at least one electronic device is formed as a die.

7. (canceled)

8. The semiconductor device module of claim 6 wherein the optical fibre is attached to the die by heat resistant adhesive.

9. The semiconductor device module of claim 8, wherein the heat resistant adhesive is a glass reinforced epoxy resin.

10. The semiconductor device module of claim 8, wherein the optical fibre is coated with a flexible coating layer.

11. The semiconductor device module of claim 10, wherein the flexible coating layer is one or more of silicone, polyimide, non-viscous cream, thermal insulating compound, and heat sink paste.

12. The semiconductor device module of claim 1, comprising a DCB, wherein the optical fibre is located inside one of the layers of the DCB.

13. The semiconductor device module of claim 1, comprising a base plate, wherein the optical fibre is located inside the base plate.

14. The semiconductor device module of claim 1, wherein the optical fibre is located in the soldering or thermal interface material between components.

15. (canceled)

16. The semiconductor device module of claim 1, wherein the module is a power electronics module.

17. A semiconductor device module control system comprising:
the semiconductor device module of claim 1;
a detector for detecting electromagnetic radiation output from the optical fibre; and
a controller coupled to the detector, and arranged to determine an operating parameter representing a condition inside the housing based on the electromagnetic radiation.

18. The semiconductor device module control system of claim 17, wherein the controller is arranged to shut off the power to the power electronics module based on the operating parameter.

19. The semiconductor device module control system of claim 18, comprising a cooling system coupled to the controller and operable based on the operating parameter.

20. A wind turbine comprising the semiconductor device module of claim 1 and/or the semiconductor device module control system of claim 17.

21. (canceled)

22. A method of detecting an operating parameter representing a condition in the housing of a semiconductor device module, comprising:
installing an optical fibre at least partially inside the housing;
inputting an optical signal into the optical fibre; and
receiving the optical signal from the optical fibre and based on the received optical signal determining the operating parameter.
